(19) United States
(12) Patent Application Publication
(10) Pub. No.: US 2026/0370569 A1
(43) Pub. Date: Nov. 19, 2026

(54) DATASET SHARING FOR AI/ML

(71) Applicant: APPLE INC., Cupertino, CA (US)

(72) Inventors: Peng Cheng, Beijing (CN); Fangli Xu, Beijing (CN); Ralf Rossbach, Munich (DE); Ping-Heng Kuo, London (GB); Yuqin Chen, Beijing (CN); Haijing Hu, Los Gatos, CA (US); Sethuraman Gurumoorthy, San Ramon, CA (US); Zhibin Wu, Los Altos, CA (US)

(21) Appl. No.: 19/147,889

(22) PCT Filed: Feb. 16, 2023
(86) PCT No.: PCT/CN2023/076444

§ 371 Date: Jul. 14, 2025

(51) Int. Cl. H04L 41/16

(52) U.S. Cl. CPC H04L 41/16

(57) ABSTRACT

Devices and methods for dataset sharing for AI/ML is provided. A first communication device comprises: at least one antenna; and a processor configured to: transmit, to a second communication device, a dataset notification including meta info of a dataset for an Artificial Intelligence (AI) model; receive, from the second communication device, a dataset request to request obtaining the dataset; and transmit, to the second communication device, a dataset report comprising the dataset.

### TECHNICAL FIELD

This application relates generally to wireless communication, including devices and methods for dataset sharing for AI/ML in wireless communication systems.

### BACKGROUND

Wireless mobile communication technology uses various standards and protocols to transmit data between a base station and a wireless device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Artificial intelligence (AI) is the simulation of human intelligence processes by machines, usually computer systems. Machine learning (ML) is a subset of AI that creates algorithms and statistical models to perform a specific task without using explicit instructions, relying instead on patterns and inference. ML algorithms build mathematical models based on sample data, called training data, to make predictions or decisions without being programmed specifically for that task. Learned signal processing algorithms can empower the next generation of wireless systems with significant reductions in power consumption and improvements in density, throughput, and accuracy when compared to the brittle and manually designed systems of today.

### SUMMARY

The present disclosure provides devices and methods for dataset sharing among different entities for AI/ML in wireless communication systems.

Embodiments disclosed herein include a first communication device, comprising: at least one antenna; and a processor configured to: transmit, to a second communication device, a dataset notification including meta info of a dataset for an Artificial Intelligence (AI) model; receive, from the second communication device, a dataset request to request obtaining the dataset; and transmit, to the second communication device, a dataset report comprising the dataset.

Embodiments disclosed herein include a second communication device, comprising: at least one antenna; and a processor configured to: receive, from a first communication device, a dataset notification including meta info of a dataset for an Artificial Intelligence (AI) model; transmit, to the first communication device, a dataset request to request obtaining the dataset; and receive, from the first communication device, a dataset report comprising the dataset.

Embodiments disclosed herein include a method performed by a first communication device, comprising: transmitting, to a second communication device, a dataset notification including meta info of a dataset for an Artificial Intelligence (AI) model; receiving, from the second communication device, a dataset request to request obtaining the dataset; and transmitting, to the second communication device, a dataset report comprising the dataset.

Embodiments disclosed herein include a method performed by a second communication device, comprising: receiving, from a first communication device, a dataset notification including meta info of a dataset for an Artificial Intelligence (AI) model; transmitting, to the first communication device, a dataset request to request obtaining the dataset; and receiving, from the first communication device, a dataset report comprising the dataset.

Embodiments disclosed herein include a non-transitory computer-readable storage medium, having instructions stored thereon, which, when executed by a processor of a first communication device, cause the processor to: transmit, to a second communication device, a dataset notification including meta info of a dataset for an Artificial Intelligence (AI) model; receive, from the second communication device, a dataset request to request obtaining the dataset; and transmit, to the second communication device, a dataset report comprising the dataset.

Embodiments disclosed herein include a non-transitory computer-readable storage medium, having instructions stored thereon, which, when executed by a processor of a second communication device, cause the processor to: receive, from a first communication device, a dataset notification including meta info of a dataset for an Artificial Intelligence (AI) model; transmit, to the first communication device, a dataset request to request obtaining the dataset; and receive, from the first communication device, a dataset report comprising the dataset.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to embodiments disclosed herein.

FIG. 2 illustrates a system for performing signaling between a wireless device and a network device, according to embodiments disclosed herein.

FIG. 3 illustrates an example functional framework of AI/ML in wireless communication systems, according to embodiments disclosed herein.

FIG. 4 illustrates an example communication procedure between a UE and a gNB for preparation of dataset sharing, according to embodiments disclosed herein.

FIG. 5 illustrates another example communication procedure among a UE, a gNB, and a Unified Data Management (UDM) for preparation of dataset sharing, according to embodiments disclosed herein.

FIG. 6 illustrates an example communication procedure for dataset sharing from a UE to a gNB, according to embodiments disclosed herein.

FIG. 7 illustrates an example communication procedure for dataset sharing from a gNB to a UE, according to embodiments disclosed herein.

FIG. 8 illustrates an example method performed by a first communication device, according to embodiments disclosed herein.

FIG. 9 illustrates an example method performed by a second communication device, according to embodiments disclosed herein.

### DETAILED DESCRIPTION

Various embodiments are described with regard to a UE. However, reference to a UE is merely provided for illustrative purposes. The example embodiments may be utilized with any wireless device that may establish a connection to a network and is configured with the hardware, software, and/or firmware to exchange information and data with the network. Therefore, the UE as described herein is used to represent any appropriate wireless device.

Various embodiments are described with regard to a gNB. However, reference to a gNB is merely provided for illustrative purposes. The example embodiments may be utilized with any network device in a network and is configured with the hardware, software, and/or firmware to implement any function of the network. Therefore, the gNB as described herein is used to represent any appropriate network device.

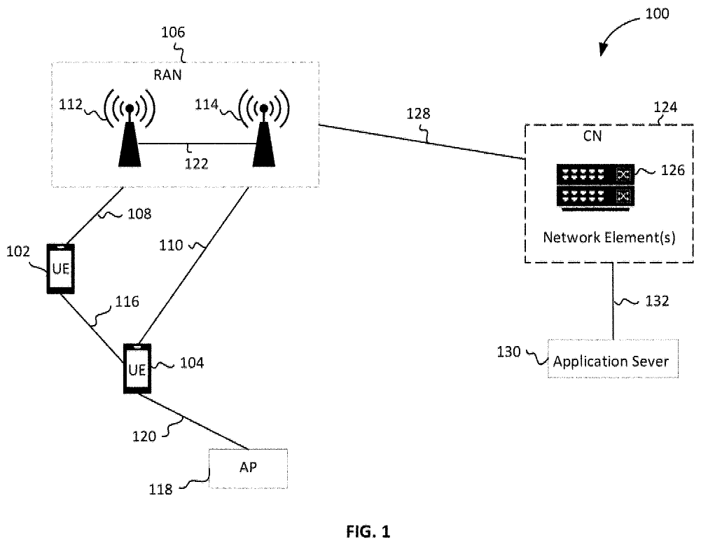

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 124).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VoIP sessions, group communication sessions, etc.) for the UE 102 and UE 104 via the CN 124. The application server 130 may communicate with the CN 124 through an IP communications interface 132.

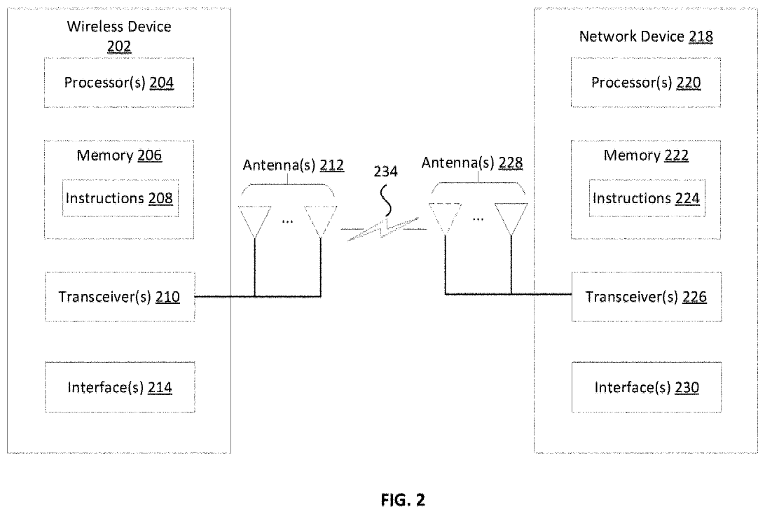

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

AI/ML can be applied to the wireless communication systems. Use cases include Channel State Information (CSI) feedback enhancement (e.g., overhead reduction, improved accuracy, and prediction), Beam Management (BM) (e.g., beam prediction in time, spatial domain for overhead and latency reduction, and beam selection accuracy improvement), and Positioning accuracy enhancements for different scenarios including, e.g., those with heavy NLOS conditions.

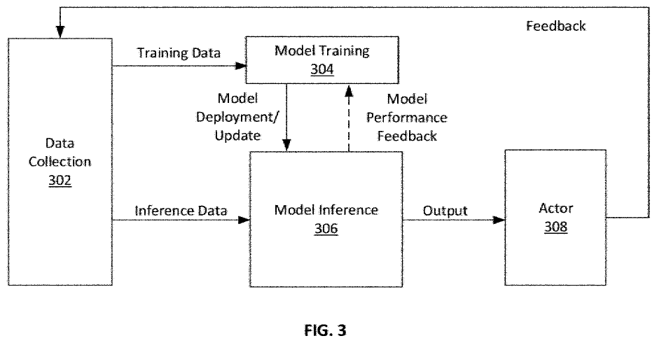

FIG. 3 illustrates an example functional framework of AI/ML in wireless communication systems, according to embodiments disclosed herein.

Data Collection 302 is a function that provides input data to Model training and Model inference functions. AI/ML algorithm specific data preparation (e.g., data pre-processing and cleaning, formatting, and transformation) is not carried out in the Data Collection function. Examples of input data may include measurements from UEs or different network entities, feedback from Actor, output from an AI/ML model. Training Data is data needed as input for the AI/ML Model Training function. Inference Data is data needed as input for the AI/ML Model Inference function.

Model Training 304 is a function that performs the AI/ML model training, validation, and testing which may generate model performance metrics as part of the model testing procedure. The Model Training function is also responsible for data preparation (e.g., data pre-processing and cleaning, formatting, and transformation) based on Training Data delivered by a Data Collection function, if required. Model Deployment/Update is to initially deploy a trained, validated, and tested AI/ML model to the Model Inference function or to deliver an updated model to the Model Inference function.

Model Inference 306 is a function that provides AI/ML model inference output (e.g., predictions or decisions). Model Inference function may provide Model Performance Feedback to Model Training function when applicable. The Model Inference function is also responsible for data preparation (e.g., data pre-processing and cleaning, formatting, and transformation) based on Inference Data delivered by a Data Collection function, if required. Output is the inference output of the AI/ML model produced by a Model Inference function. Details of inference output are use case specific. Model Performance Feedback may be used for monitoring the performance of the AI/ML model, when available.

Actor 308 is a function that receives the output from the Model Inference function and triggers or performs corresponding actions. The Actor may trigger actions directed to other entities or to itself. Feedback is information that may be needed to derive training data, inference data or to monitor (e.g., by a Model Monitoring function) the performance of the AI/ML Model and its impact to the network through updating of KPIs and performance counters.

Dataset needed for model training, model monitoring or model inference at an entity may be shared from other entities. The present disclosure provides devices and methods for dataset sharing among different entities for AI/ML in wireless communication systems.

Example communication procedures will be described below to illustrate various aspects of the present disclosure. The example communication procedures are described with regard to AI. However, reference to AI is merely provided for illustrative purposes, and it can be replaced with ML.

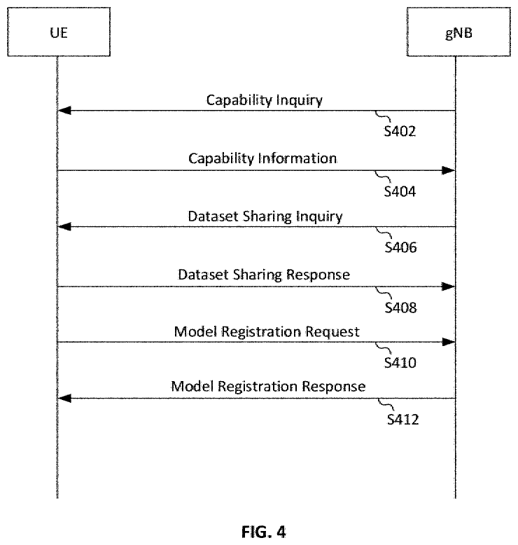

FIG. 4 illustrates an example communication procedure between a UE and a gNB for preparation of dataset sharing, according to embodiments disclosed herein. The preparation of dataset sharing comprises exchange of AI capability, dataset sharing consent, and model registration, and may be performed before data sharing among different entities.

Firstly, exchange of AI capability is performed between the UE and the gNB. At step 402, the gNB transmits a capability inquiry to UE when it needs know the UE's capability of AI. At step S404, the UE transmits capability information indicating the UE's capability of AI to the gNB in response to the received capability inquiry.

Then, exchange of dataset sharing consent is performed between the UE and the gNB. At step 406, the gNB transmits a dataset sharing inquiry to the UE to inquire whether dataset sharing is consented to by the UE. At step 408, in response to the received dataset sharing inquiry, the UE transmits a dataset sharing response indicating consent of the UE to dataset sharing.

Lastly, model registration is performed between the US and the gNB. At step S410, the UE transmits a model registration request to the UE to register a list of AI models available at the UE to the gNB. The model registration request may include model IDs of the available AI models. In some implementations, the model IDs may be generated by the UE, which are unique in PLMN. For example, PLMN info may be a part of the model IDs. In some implementations, the model IDs may be assigned by the network. The model registration request may further include meta info of the available AI models. The meta info of an AI model describes the AI model, and may include one or more of training status, use case, functionality/object (e.g. input/output of the AI model), requirements/performance (e.g. latency benchmarks of the ML model, memory requirements of the ML model, accuracy of the ML model), compression status of the AI model, or inferencing/operating condition (e.g. Urban, indoor, dense macro, SINR). The model registration request may further include model status of the AI models at the UE, e.g. support but not download yet, well trained, not-well trained, etc.

At step S412, the gNB transmits a model registration response to the UE in response to the received model registration request. The model registration response may include model IDs of supported AI models. If sub-dataset IDs are assigned to an AI model of the supported AI models, the model registration response may further include the sub-dataset IDs. The sub-dataset IDs can identify sub-dataset of the dataset of the AI model. If sub-dataset IDs are not assigned, the dataset for the AI model can be identified by the model ID of the AI model. That is, one model ID can identify one dataset.

The model registration request and model registration response exchanged between the UE and the gNB on AI model registration may be Radio Resource Control (RRC) message, a Non-Access stratum (NAS) message or User Plane (UP) traffic. The UE may send the model registration request upon change of its list of available AI models. If the model registration request is UP traffic, it can be a part of an IP payload (i.e. part of IP packet), or it can be included in a new Layer 2 Control PDU with a special QFI (QoS flow identity), or it can be included in a reserved DRB (data radio bearer), or it can follow a Media Access Control (MAC) Control Element (CE). Network termination entity of the model registration request may be different depending on different types of the model registration request. For example, the model info may be stored in gNB if the model registration request is a RRC message, or the model info may be stored in Core Network if the model registration request is a NAS message, or the model info may be stored in OAM if the model registration request is UP traffic.

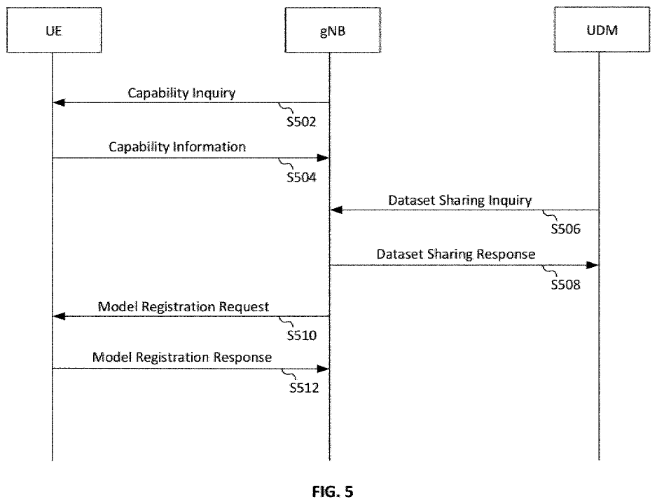

FIG. 5 illustrates another example communication procedure among a UE, a gNB, and a Unified Data Management (UDM) for preparation of dataset sharing, according to embodiments disclosed herein. The preparation of dataset sharing comprises exchange of AI capability, dataset sharing consent, and model registration, and may be performed before data sharing among different entities. The steps S502 and S504 for exchange of AI capability can be the same as steps S402 and S404 of FIG. 4, and the steps S510 and S512 for exchange of model registration can be the same as the steps S410 and S412 of FIG. 4. However, the steps S506 and S508 for exchange of dataset sharing consent are different from steps S406 and S408 of FIG. 4. In FIG. 5, the gNB acquires dataset sharing consent of the UE from the UDM instead of the UE. At step S506, the gNB transmits, to the UDM, a dataset sharing inquiry inquiring whether dataset sharing is consented to by the UE. At step S508, the gNB receives, from the UDM, a dataset sharing response indicating consent of the UE to dataset sharing.

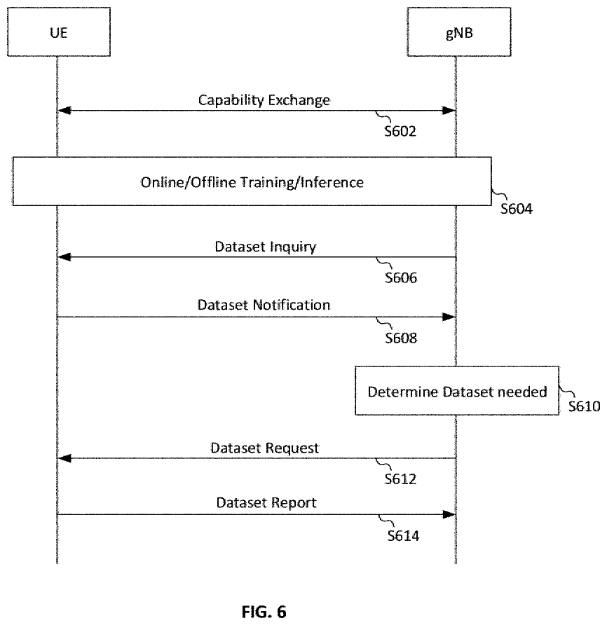

FIG. 6 illustrates an example communication procedure for dataset sharing from a UE to a gNB, according to embodiments disclosed herein. Before dataset sharing, capability exchange and online/offline training/inference may be performed between the UE and gNB. At step S602, capability exchange is performed between the UE and the gNB, such that the gNB can know AI capability of the UE. Examples of the capability exchange include steps S402 and S404 of FIG. 4, and steps S502 and S504 of FIG. 5. At step S604, online/offline training/inference may be performed by the UE and/or the gNB.

Then, dataset sharing may be performed between the UE and the gNB. Due to large payload overhead and different data quality, dataset may not always need to be transferred between gNB and UE. If some critical information of the dataset can be first exchanged between UE and gNB, necessity of transfer of the dataset may be decided based on the information, and unnecessary transfer can be avoided, and thus communication overhead can be reduced.

At step S608, the UE transmits, to the gNB, a dataset notification to indicate that there is a dataset for an AI model available at the UE. The dataset notification may be a RRC message, and may include model ID of the AI model. The dataset notification may further include meta info of the dataset. The meta info of the dataset describes the dataset, and may include one or more of: data type (e.g., measurement, or ground-truth label), data usage (e.g., model training, model monitoring, or model inference), use case (e.g. CSI compression, beam management, positioning) which indicates outcome of applying the AI model, sample amount, payload size or required memory size before and/or after compression, latest update time (e.g., timestamp for latest update time), environment info (e.g. SINR/RSRP/RSRQ value/histogram, UE location, serving/neighboring cell ID), or percentage of singular data samples. To enhance privacy, the use case can be indicated indirectly, e.g., by using an identifier.

The dataset notification may further comprise a dataset quality of the dataset. The dataset quality of the dataset may comprise one or more of accuracy (e.g., inference accuracy, training accuracy, and ground-truth label accuracy), variance, integrity, or latency (e.g., delay between raw data is generated and the UE gathers these data).

In some implementations, the dataset notification may be transmitted on-request, e.g. in response to a dataset inquiry transmitted from the gNB to inquiry whether there is any dataset for the AI model available at the UE at step S606. The dataset inquiry may be a RRC message, and may include a model ID of the AI model, and may further include a data type (e.g., measurement, or ground-truth label) of the dataset. If sub-dataset ID is assigned, the dataset notification may further include the sub-dataset ID after the model ID.

In some implementations, step S606 is not necessary, and the dataset notification may be transmitted periodically. A time interval to transmit the dataset notification may be configured by RRC message (e.g. RRCReconfiguration).

In some implementations, step S606 is not necessary, and the dataset notification may be triggered by an event (e.g., a condition is satisfied). The condition may be configured by a RRC message (e.g. RRCReconfiguration), and may include one or more thresholds of dataset quality.

At step S610, the gNB determines the dataset is needed. The gNB may determine the dataset is needed based on the meta info of the dataset. In addition, the gNB may determine the dataset is needed based on the dataset quality, e.g., the dataset quality is above a threshold. In such manner, the gNB may obtain a dataset with good quality, and transmission of a dataset with bad quality can be avoided, and thus communication overhead can be reduced.

At step S612, the gNB transmits, to the UE, a dataset request to request obtaining the dataset, in response the determination of step 610. The dataset request may include the model ID of the AI model, and may further include the data type (e.g., measurement, or ground-truth label) of the dataset. If sub-dataset ID is assigned, the dataset request may further include the sub-dataset ID after the model ID. Similar to the dataset inquiry, the dataset request may be transmitted on-request, periodically or triggered by an event.

The dataset request may be a RRC message or UP traffic. If the dataset request is RRC message, then a new RRC message (e.g. DatasetRequest) can be introduced to support on-request transmission of the dataset request. A prohibit timer can be configured to be associated with the dataset request, to avoid too frequent transmission of the dataset request. If the dataset request is UP traffic, it may be a part of the IP payload (i.e. part of IP packet), or in a new Layer 2 Control PDU with a special QFI (QoS flow identity) or reserved DRB (data radio bearer), or following a Media Access Control (MAC) Control Element (CE).

At step S614, the UE transmits, to the gNB, a dataset report including the dataset. The dataset report may further include model ID, meta info, and dataset quality. In some implementations, the dataset report is a RRC message. An address to download the dataset from a server (e.g., a server URL) is included in the RRC message, or the dataset is included in a transparent container of the RRC message. The model ID, meta info, and dataset quality (if necessary) is included in IE (Information Element) of the RRC message. Therefore, the dataset may be transferred as a server URL or in an existing open format. In some implementations, the dataset report is a Non-Access stratum (NAS) message. In some implementations, the dataset report is User Plane (UP) traffic. For example, the UP traffic may be part of an IP packet or is in a Layer 2 Control PDU with a reserved 5G QoS indication (5QI) or QoS flow identity (QFI). For another example, the over a reserved data radio bearer (DRB), or the UP traffic may be established via a specific control signaling with a reserved 5QI or QFI, or the UP traffic may follow a Media Access Control (MAC) Control Element (CE). For yet another example, the control signaling to establish the PDU session to include dataset may use a reserved 5QI/QFI. The established PDU session may be assigned with different 5QI/QFI depending on different requirements of dataset transfer. This is more flexible if the UE needs to transfer more than one datasets.

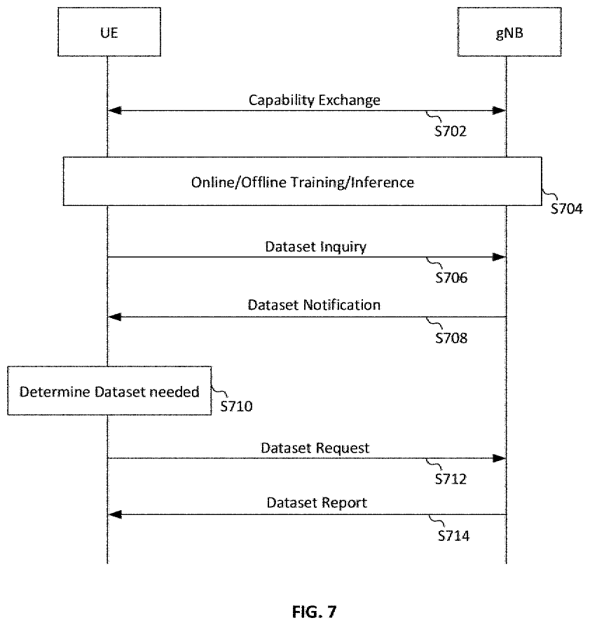

FIG. 7 illustrates an example communication procedure for dataset sharing from a gNB to a UE, according to embodiments disclosed herein. Before dataset sharing, capability exchange and online/offline training/inference may be performed between the UE and gNB. At step S702, capability exchange is performed between the UE and the gNB, such that the gNB can know AI capability of the UE. Examples of the capability exchange include steps S402 and S404 of FIG. 4, and steps S502 and S504 of FIG. 5. At step S704, online/offline training/inference may be performed by the UE and/or the gNB.

Then, dataset sharing may be performed between the UE and the gNB. Due to large payload overhead and different data quality, dataset may not always need to be transferred between gNB and UE. If some critical information of the dataset can be first exchanged between UE and gNB, necessity of transfer of the dataset may be decided based on the information, and unnecessary transfer can be avoided, and thus communication overhead can be reduced.

At step S708, the gNB transmits, to the UE, a dataset notification to indicate that there is a dataset for an AI model available at the gNB. The dataset notification may be a RRC message, and may include model ID of the AI model. The dataset notification may further include meta info of the dataset. The meta info of the dataset describes the dataset, and may include one or more of: data type (e.g., measurement, or ground-truth label), data usage (e.g., model training, model monitoring, or model inference), use case (e.g. CSI compression, beam management, positioning) which indicates outcome of applying the AI model, sample amount, payload size or required memory size before and/or after compression, latest update time (e.g., timestamp for latest update time), environment info (e.g. SINR/RSRP/RSRQ value/histogram, gNB location, serving/neighboring cell ID), or percentage of singular data samples. To enhance privacy, the use case can be indicated indirectly, e.g., by using an identifier.

The dataset notification may further comprise a dataset quality of the dataset. The dataset quality of the dataset may comprise one or more of accuracy (e.g., inference accuracy, training accuracy, and ground-truth label accuracy), variance, integrity, or latency (e.g., delay between raw data is generated and the UE gathers these data).

In some implementations, the dataset notification may be transmitted on-request, e.g. in response to a dataset inquiry transmitted from the UE to inquiry whether there is any dataset for the AI model available at the gNB at step S706. The dataset inquiry may be a RRC message, and may include a model ID of the AI model, and may further include a data type (e.g., measurement, or ground-truth label) of the dataset. If sub-dataset ID is assigned, the dataset notification may further include the sub-dataset ID after the model ID. The dataset notification may be a RRC message (e.g. UE Assistance Information or DatasetQualityRequest).

In some implementations, step S706 is not necessary, and the dataset notification may be transmitted periodically. However, it may be up to gNB implementation whether/when to send the dataset notification.

At step S710, the UE determines the dataset is needed. The UE may determine the dataset is needed based on the meta info of the dataset. In addition, the UE may determine the dataset is needed based on the dataset quality, e.g., the dataset quality is above a threshold. In such manner, the UE may obtain a dataset with good quality, and transmission of a dataset with bad quality can be avoided, and thus communication overhead can be reduced.

At step S712, the UE transmits, to the gNB, a dataset request to request obtaining the dataset, in response the determination of step 710. The dataset request may include the model ID of the AI model, and may further include the data type (e.g., measurement, or ground-truth label) of the dataset. If sub-dataset ID is assigned, the dataset request may further include the sub-dataset ID after the model ID. Similar to the dataset inquiry, the dataset request may be transmitted on-request or periodically or triggered by an event.

The dataset request may be a RRC message or UP traffic. If the dataset request is RRC message, then a new RRC message (e.g. DatasetRequest) can be introduced to support on-request transmission of the dataset request. A prohibit timer can be configured to be associated with the dataset request, to avoid too frequent transmission of the dataset request. If the dataset request is UP traffic, it may be a part of the IP payload (i.e. part of IP packet), or in a new Layer 2 Control PDU with a special QFI (QoS flow identity) or reserved DRB (data radio bearer), or following a Media Access Control (MAC) Control Element (CE).

At step S714, the gNB transmits, to the UE, a dataset report including the dataset. The dataset report may further include model ID, meta info, and dataset quality. In some implementations, the dataset report is a RRC message. An address to download the dataset from a server (e.g., a server URL) is included in the RRC message, or the dataset is included in a transparent container of the RRC message. The model ID, meta info, and dataset quality (if necessary) may be included in IE (Information Element) of the RRC message. Therefore, the dataset may be transferred as a server URL or in an existing open format. In some implementations, the dataset report is a Non-Access stratum (NAS) message. In some implementations, the dataset report is User Plane (UP) traffic. For example, the UP traffic may be part of an IP packet or is in a Layer 2 Control PDU with a reserved 5G QoS indication (5QI) or QoS flow identity (QFI). For another example, the over a reserved data radio bearer (DRB), or the UP traffic may be established via a specific control signaling with a reserved 5QI or QFI, or the UP traffic may follow a Media Access Control (MAC) Control Element (CE). For yet another example, the control signaling to establish the PDU session to include dataset may use a reserved 5QI/QFI. The established PDU session may be assigned with different 5QI/QFI depending on different requirements of dataset transfer. This is more flexible if the gNB needs to transfer more than one datasets. However, it may be up to gNB implementation whether/when to deliver dataset report to UE via RRC message or UP traffic.

In the present disclosure, RRC message, NAS message, and UP traffic may be selected according to different requirements of latency, robustness, payload size of actual systems. RRC message may result in low signaling latency than NAS and UP, because it is terminated in gNB. It can apply delta configuration, and is more robust than UP traffic. However, it can't deliver dataset with large payload size, and segmentation needs to be supported by the RRC message, which is a higher requirement on RRC message. NAS message may be more robust than UP traffic, and support deliver of dataset with large payload size. However, it may result in high latency compared with RRC message. UP traffic support delivery of dataset with large payload size. However, it results in high latency compared with RRC message, and is not robust than RRC and NAS.

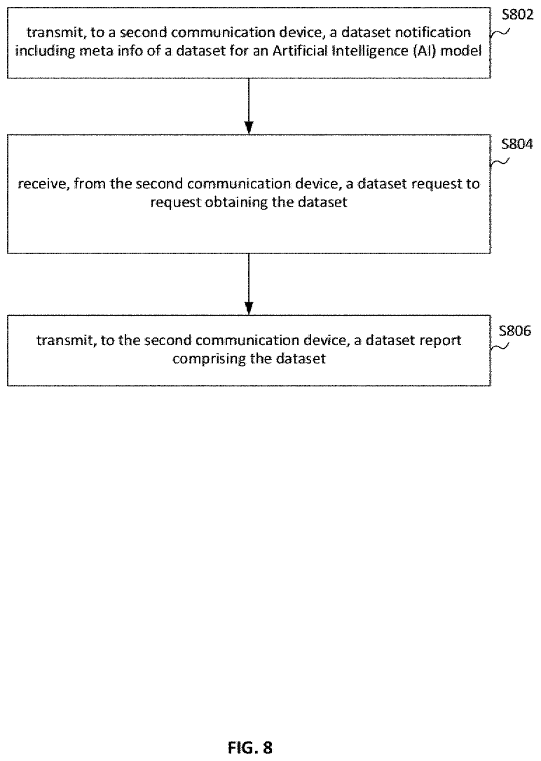

FIG. 8 illustrates an example method performed by a first communication device, according to embodiments disclosed herein. At step S802, the first communication device transmits, to a second communication device, a dataset notification including meta info of a dataset for an Artificial Intelligence (AI) model. At step S804, the first communication device receives, from the second communication device, a dataset request to request obtaining the dataset. At step S806, the first communication device transmits, to the second communication device, a dataset report comprising the dataset.

Any of the steps described above with reference to UE in FIG. 6 or any of the steps described above with reference to gNB in FIG. 7 can be performed by the first communication device, and are not repeatedly described here for brevity's sake. In addition, not all of the steps shown in FIG. 8 are necessary, and the first communication device may only perform one or more of the steps.

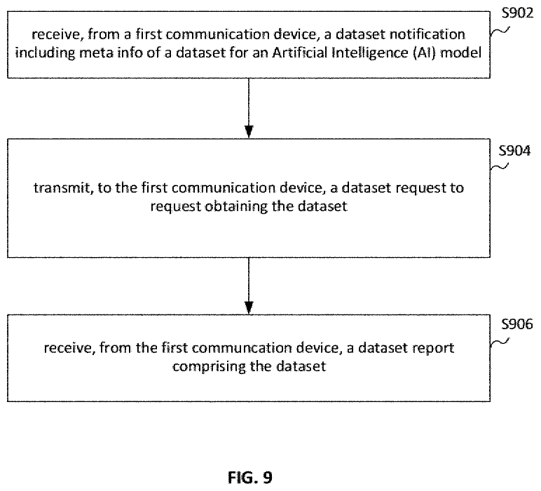

FIG. 9 illustrates an example method performed by a second communication device, according to embodiments disclosed herein. At step S902, the second communication device receives receive, from a first communication device, a dataset notification including meta info of a dataset for an Artificial Intelligence (AI) model. At step S904, the second communication device transmits, to the first communication device, a dataset request to request obtaining the dataset. At step S906, the second communication device receives, from the first communication device, a dataset report comprising the dataset.

Any of the steps described above with reference to gNB in FIG. 6 or any of the steps described above with reference to UE in FIG. 7 can be performed by the second communication device, and are not repeatedly described here for brevity's sake. In addition, not all of the steps shown in FIG. 9 are necessary, and the second communication device may only perform one or more of the steps.

Embodiments contemplated herein include a first communication device, comprising: at least one antenna; and a processor configured to: transmit, to a second communication device, a dataset notification including meta info of a dataset for an Artificial Intelligence (AI) model; receive, from the second communication device, a dataset request to request obtaining the dataset; and transmit, to the second communication device, a dataset report comprising the dataset.

In some embodiments of the present disclosure, the dataset notification is transmitted periodically or is triggered by an event.

In some embodiments of the present disclosure, the processor is further configured to receive, from the second communication device, a dataset inquiry to inquiry whether there is any dataset for the AI model, and wherein the dataset notification is transmitted in response to the dataset inquiry.

In some embodiments of the present disclosure, the dataset inquiry further comprises a data type of the dataset.

In some embodiments of the present disclosure, the meta info of the dataset comprises one or more of: data type, data usage, use case, sample amount, payload size or required memory size, latest update time, environment info, or percentage of singular data samples.

In some embodiments of the present disclosure, the dataset notification further comprises a dataset quality of the dataset.

In some embodiments of the present disclosure, the dataset quality comprises one or more of: accuracy, variance, integrity, or latency.

In some embodiments of the present disclosure, the dataset report is a Radio Resource Control (RRC) message, and the dataset is included in a transparent container of the RRC message.

In some embodiments of the present disclosure, the dataset report is a Radio Resource Control (RRC) message, and an address to download the dataset from a server is included in the RRC message.

In some embodiments of the present disclosure, the dataset report is a Non-Access stratum (NAS) message.

In some embodiments of the present disclosure, the dataset report is User Plane (UP) traffic.

In some embodiments of the present disclosure, the UP traffic is part of an IP packet or is in a Layer 2 Control PDU with a reserved 5G QoS indication (5QI) or QoS flow identity (QFI), or over a reserved data radio bearer (DRB); the UP traffic is established via a specific control signaling with a reserved 5QI or QFI; or the UP traffic follows a Media Access Control (MAC) Control Element (CE).

In some embodiments of the present disclosure, the processor is further configured to: receive, from the second communication device, a dataset sharing inquiry inquiring whether dataset sharing is consented to by the first communication device; and transmit, to the second communication device, a dataset sharing response indicating consent of the first communication device to dataset sharing.

In some embodiments of the present disclosure, the processor is further configured to: transmit, to the second communication device, a model registration request including model IDs of available AI models and model description of the available AI models; and receive, from the second communication device, a model registration response including model IDs of supported AI models.

In some embodiments of the present disclosure, the model registration response further includes sub-dataset IDs assigned to at least one of the supported AI models.

In some embodiments of the present disclosure, each of the model registration request and the model registration response is a Radio Resource Control (RRC) message, a Non-Access stratum (NAS) message or User Plane (UP) traffic.

Embodiments contemplated herein include an apparatus comprising means to perform one or more elements of the method comprising: transmitting, to a second communication device, a dataset notification including meta info of a dataset for an Artificial Intelligence (AI) model; receiving, from the second communication device, a dataset request to request obtaining the dataset; and transmitting, to the second communication device, a dataset report comprising the dataset. This apparatus may be, for example, an apparatus of the UE in FIG. 6 or an apparatus of the gNB in FIG. 7.

Embodiments contemplated herein include one or more non-transitory computer-readable media comprising instructions to cause an electronic device, upon execution of the instructions by one or more processors of the electronic device, to perform one or more elements of the method comprising: transmitting, to a second communication device, a dataset notification including meta info of a dataset for an Artificial Intelligence (AI) model; receiving, from the second communication device, a dataset request to request obtaining the dataset; and transmitting, to the second communication device, a dataset report comprising the dataset. This non-transitory computer-readable media may be, for example, a memory of the UE in FIG. 6 or a memory of the gNB in FIG. 7.

Embodiments contemplated herein include an apparatus comprising logic, modules, or circuitry to perform one or more elements of the method comprising: transmitting, to a second communication device, a dataset notification including meta info of a dataset for an Artificial Intelligence (AI) model; receiving, from the second communication device, a dataset request to request obtaining the dataset; and transmitting, to the second communication device, a dataset report comprising the dataset. This apparatus may be, for example, an apparatus of the UE in FIG. 6 or an apparatus of the gNB in FIG. 7.

Embodiments contemplated herein include an apparatus comprising: one or more processors and one or more computer-readable media comprising instructions that, when executed by the one or more processors, cause the one or more processors to perform one or more elements of the method comprising: transmitting, to a second communication device, a dataset notification including meta info of a dataset for an Artificial Intelligence (AI) model; receiving, from the second communication device, a dataset request to request obtaining the dataset; and transmitting, to the second communication device, a dataset report comprising the dataset. This apparatus may be, for example, an apparatus of the UE in FIG. 6 or an apparatus of the gNB in FIG. 7.

Embodiments contemplated herein include a signal as described in or related to one or more elements of the method comprising: transmitting, to a second communication device, a dataset notification including meta info of a dataset for an Artificial Intelligence (AI) model; receiving, from the second communication device, a dataset request to request obtaining the dataset; and transmitting, to the second communication device, a dataset report comprising the dataset.

Embodiments contemplated herein include a computer program or computer program product comprising instructions, wherein execution of the program by a processor is to cause the processor to carry out one or more elements of the method comprising: transmitting, to a second communication device, a dataset notification including meta info of a dataset for an Artificial Intelligence (AI) model; receiving, from the second communication device, a dataset request to request obtaining the dataset; and transmitting, to the second communication device, a dataset report comprising the dataset. The processor may be a processor of the UE in FIG. 6 or a processor of the gNB in FIG. 7. These instructions may be, for example, located in the processor and/or on a memory of the UE in FIG. 6 or the gNB in FIG. 7.

Embodiments contemplated herein include a second communication device, comprising: at least one antenna; and a processor configured to: receive, from a first communication device, a dataset notification including meta info of a dataset for an Artificial Intelligence (AI) model; transmit, to the first communication device, a dataset request to request obtaining the dataset; and receive, from the first communication device, a dataset report comprising the dataset.

In some embodiments of the present disclosure, the dataset notification is transmitted periodically.

In some embodiments of the present disclosure, the processor is further configured to transmit, to the first communication device, a dataset inquiry to inquiry whether there is any dataset for the AI model.

In some embodiments of the present disclosure, the dataset inquiry further comprises a data type of the dataset.

In some embodiments of the present disclosure, the meta info of the dataset comprises one or more of: data type, data usage, use case, sample amount, payload size or required memory size, latest update time, environment info, or percentage of singular data samples.

In some embodiments of the present disclosure, the dataset notification further comprises a dataset quality of the dataset.

In some embodiments of the present disclosure, the dataset quality comprises one or more of: accuracy, variance, integrity, or latency.

In some embodiments of the present disclosure, the processor is further configured to: transmit, to the first communication device, a dataset sharing inquiry inquiring whether dataset sharing is consented to by the first communication device; and receive, from the first communication device, a dataset sharing response indicating consent of the first communication device to dataset sharing.

In some embodiments of the present disclosure, the processor is further configured to: transmit, to a Unified Data Management (UDM), a dataset sharing inquiry inquiring whether dataset sharing is consented to by the first communication device; and receive, from the UDM, a dataset sharing response indicating consent of the first communication device to dataset sharing.

In some embodiments of the present disclosure, the processor is further configured to: receive, from the first communication device, a model registration request including model IDs of available AI models and model description of the available AI models; and transmit, to the first communication device, a model registration response including model IDs of supported AI models.

In some embodiments of the present disclosure, the model registration response further includes sub-dataset IDs assigned to at least one of the supported AI models.

Embodiments contemplated herein include an apparatus comprising means to perform one or more elements of the method comprising: receiving, from a first communication device, a dataset notification including meta info of a dataset for an Artificial Intelligence (AI) model; transmitting, to the first communication device, a dataset request to request obtaining the dataset; and receiving, from the first communication device, a dataset report comprising the dataset. This apparatus may be, for example, an apparatus of the gNB in FIG. 6 or the UE in FIG. 7.

Embodiments contemplated herein include one or more non-transitory computer-readable media comprising instructions to cause an electronic device, upon execution of the instructions by one or more processors of the electronic device, to perform one or more elements of the method comprising: receiving, from a first communication device, a dataset notification including meta info of a dataset for an Artificial Intelligence (AI) model; transmitting, to the first communication device, a dataset request to request obtaining the dataset; and receiving, from the first communication device, a dataset report comprising the dataset. This non-transitory computer-readable media may be, for example, a memory of the gNB in FIG. 6 or the UE in FIG. 7.

Embodiments contemplated herein include an apparatus comprising logic, modules, or circuitry to perform one or more elements of the method comprising: receiving, from a first communication device, a dataset notification including meta info of a dataset for an Artificial Intelligence (AI) model; transmitting, to the first communication device, a dataset request to request obtaining the dataset; and receiving, from the first communication device, a dataset report comprising the dataset. This apparatus may be, for example, an apparatus of the gNB in FIG. 6 or the UE in FIG. 7.

Embodiments contemplated herein include an apparatus comprising: one or more processors and one or more computer-readable media comprising instructions that, when executed by the one or more processors, cause the one or more processors to perform one or more elements of the method comprising: receiving, from a first communication device, a dataset notification including meta info of a dataset for an Artificial Intelligence (AI) model; transmitting, to the first communication device, a dataset request to request obtaining the dataset; and receiving, from the first communication device, a dataset report comprising the dataset. This apparatus may be, for example, an apparatus of the gNB in FIG. 6 or the UE in FIG. 7.

Embodiments contemplated herein include a signal as described in or related to one or more elements of the method comprising: receiving, from a first communication device, a dataset notification including meta info of a dataset for an Artificial Intelligence (AI) model; transmitting, to the first communication device, a dataset request to request obtaining the dataset; and receiving, from the first communication device, a dataset report comprising the dataset.

Embodiments contemplated herein include a computer program or computer program product comprising instructions, wherein execution of the program by a processing element is to cause the processing element to carry out one or more elements of the method comprising: receiving, from a first communication device, a dataset notification including meta info of a dataset for an Artificial Intelligence (AI) model; transmitting, to the first communication device, a dataset request to request obtaining the dataset; and receiving, from the first communication device, a dataset report comprising the dataset. The processor may be a processor of the gNB in FIG. 6 or the UE in FIG. 7. These instructions may be, for example, located in the processor and/or on a memory of the gNB in FIG. 6 or the UE in FIG. 7.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A first communication device, comprising:
at least one antenna; and
a processor configured to:
transmit, to a second communication device, a dataset notification including meta info of a dataset for an Artificial Intelligence (AI) model;
receive, from the second communication device, a dataset request to request obtaining the dataset; and
transmit, to the second communication device, a dataset report comprising the dataset.

2. The first communication device of claim 1, wherein the dataset notification is transmitted periodically or is triggered by an event.

3. The first communication device of claim 1, wherein the processor is further configured to receive, from the second communication device, a dataset inquiry to inquiry whether there is any dataset for the AI model, and wherein the dataset notification is transmitted in response to the dataset inquiry.

4. The first communication device of claim 3, wherein the dataset inquiry further comprises a data type of the dataset.

5. The first communication device of claim 1, wherein the meta info of the dataset comprises one or more of: data type, data usage, use case, sample amount, payload size or required memory size, latest update time, environment info, or percentage of singular data samples.

6. The first communication device of claim 1, wherein the dataset notification further comprises a dataset quality of the dataset.

7. The first communication device of claim 6, wherein the dataset quality comprises one or more of: accuracy, variance, integrity, or latency.

8. The first communication device of claim 1, wherein the dataset report is a Radio Resource Control (RRC) message, and the dataset is included in a transparent container of the RRC message.

9. The first communication device of claim 1, wherein the dataset report is a Radio Resource Control (RRC) message, and an address to download the dataset from a server is included in the RRC message.

10. The first communication device of claim 1, wherein the dataset report is a Non-Access stratum (NAS) message.

11. The first communication device of claim 1, wherein the dataset report is User Plane (UP) traffic.

12. The first communication device of claim 11, wherein one of the following:
the UP traffic is part of an IP packet or is in a Layer 2 Control PDU with a reserved 5G QoS indication (5QI) or QoS flow identity (QFI), or over a reserved data radio bearer (DRB);
the UP traffic is established via a specific control signaling with a reserved 5QI or QFI; or
the UP traffic follows a Media Access Control (MAC) Control Element (CE).

13. The first communication device of claim 1, wherein the processor is further configured to:
receive, from the second communication device, a dataset sharing inquiry inquiring whether dataset sharing is consented to by the first communication device; and
transmit, to the second communication device, a dataset sharing response indicating consent of the first communication device to dataset sharing.

14. The first communication device of claim 1, wherein the processor is further configured to:
transmit, to the second communication device, a model registration request including model IDs of available AI models and model description of the available AI models; and
receive, from the second communication device, a model registration response including model IDs of supported AI models.

15. The first communication device of claim 14, wherein the model registration response further includes sub-dataset IDs assigned to at least one of the supported AI models.

16. The first communication device of claim 14, wherein each of the model registration request and the model registration response is a Radio Resource Control (RRC) message, a Non-Access stratum (NAS) message or User Plane (UP) traffic.

17. A second communication device, comprising:
at least one antenna; and
a processor configured to:
receive, from a first communication device, a dataset notification including meta info of a dataset for an Artificial Intelligence (AI) model;
transmit, to the first communication device, a dataset request to request obtaining the dataset; and
receive, from the first communication device, a dataset report comprising the dataset.

18. The second communication device of claim 17, wherein the dataset notification is transmitted periodically.

19. The second communication device of claim 17, wherein the processor is further configured to transmit, to the first communication device, a dataset inquiry to inquiry whether there is any dataset for the AI model.

20. The second communication device of claim 19, wherein the dataset inquiry further comprises a data type of the dataset.

21-31. (canceled)
